(19) United States
(12) Patent Application Publication
(10) Pub. No.: US 2024/0086639 A1
(43) Pub. Date: Mar. 14, 2024

(54) AUTOMATICALLY LOCATING RESPONSES TO PREVIOUSLY ASKED QUESTIONS IN A LIVE CHAT TRANSCRIPT USING ARTIFICIAL INTELLIGENCE (AI)

(71) Applicant: INTERNATIONAL BUSINESS MACHINES CORPORATION, ARMONK, NY (US)

(72) Inventors: Sanket Jain, Gurgaon (IN); Krishnasuri Narayanam, Bangalore (IN); Ratnakar Behera, Bangalore (IN); Avinash Tukaram Mane, Chinchwad (IN); ZHENG XIE, Clontarf (IE); JOY PATRA, Dublin (IE)

(21) Appl. No.: 17/931,911

(22) Filed: Sep. 14, 2022

(51) Int. Cl. G06F 40/30; G06F 40/279; G10L 15/06; G10L 15/18; G10L 15/22

(52) U.S. Cl. CPC G06F 40/30; G06F 40/279; G10L 15/063; G10L 15/1815; G10L 15/22

(57) ABSTRACT

Method, computer program product, and computer system are provided. A model is trained, in real-time to identify likely duplicate questions. A level of duplication is identified between a question and a previously asked question in a meeting transcript. An asker is pointed to where in the meeting transcript the question was the previously asked. All duplicate questions are arranged in a single point question by topic. A new meeting transcript is generated and displayed to attendees, including each individual question and each single point question.

### BACKGROUND

The present invention relates to computer systems, and more specifically to locating responses in live chat using artificial intelligence (AI).

It is increasingly the case that employees work remotely and attend meetings using teleconferencing software. Similarly, students increasingly attend webinars using network-based applications, such as Zoom. (Zoom and the Zoom logo are trademarks of Zoom Video Communications, Inc.). Typically, one or more attendants monitor the chat window, and filter out the duplicate questions. The unique questions are read to the presenter to answer. This approach needs additional personnel to manage the presentation and/or meeting. Participants can repeat questions that were previously asked, thereby interrupting the flow of the meeting. Additionally, duplicate questions can create an impression that the attendees are not paying attention, or that the presenter is not clearly conveying the subject matter.

It would be advantageous to automatically locate and present responses to previously asked questions during a live chat.

### SUMMARY

A method is provided. A model is trained, in real-time to identify likely duplicate questions. A level of duplication is identified between a question and a previously asked question in a meeting transcript. An asker is pointed to where in the meeting transcript the question was the previously asked. All duplicate questions are arranged in a single point question by topic. A new meeting transcript is generated and displayed to attendees, including each individual question and each single point question.

Embodiments are further directed to computer systems and computer program products having substantially the same features as the above-described computer-implemented method.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates the operating environment of a computer server, according to an embodiment of the present invention;

FIG. 2 illustrates a process flow for automatically pointing in a live chat transcript to previously asked question, in accordance with one or more aspects of the present invention;

FIG. 3 illustrates a process flow for natural language processing (NLP) in real time of live meetings, in accordance with one or more aspects of the present invention; and

FIG. 4 illustrates a process flow for generating aggregate duplicate questions, in accordance with one or more aspects of the present invention.

### DETAILED DESCRIPTION

It is increasingly the case that employees work remotely and attend meetings using teleconferencing software. Similarly, students increasingly attend webinars using network-based applications, such as Zoom. Typically, one or more attendants monitor the chat window, and filter out the duplicate questions. The unique questions are read to the presenter to answer. This approach takes additional personnel to manage the presentation and/or meeting. Participants can repeat questions that were previously asked, thereby interrupting the flow of the meeting. The interruption may be major, for example, where there are several hundred attendees. Additionally, duplicate questions can create an impression that the attendees are not paying attention, or that the presenter is not clearly conveying the subject matter. Therefore, embodiments of the present invention tend to improve time management through selecting the most filtered questions that are relevant to the topic. In the case of a meeting series, such as online classes, experience from prior sessions is captured in the model and leveraged to improve future NLP processing of transcripts.

Embodiments of the present invention use NLP and intent recognition to train a model based on general teleconferencing content and scripts so that the model understands typical teleconferencing language. Additional layers of training can be build based on a series of teleconference session, such as a training class or recurring status review meetings. Further, the model can be trained to customize NLP capabilities for groups, for example, for hardware engineers, so that the model is tailored for the cliches and acronyms of the group. Inputs to the model include past Q&A data from a stored source and current content from the meeting periodically captured according to a configurable schedule. The various embodiments can be implemented as an integrated supplementary component to a teleconferencing application, such as Zoom. The embodiments access various application programming interfaces (APIs) to access the data of the teleconferencing application, such as the chat transcript, the participants, and the meeting content. Also, the teleconferencing application performs audio to text captioning, which can be available through an API.

The question analysis may be performed by a combination of various IBM Watson™ APIs. For example, IBM Watson™ Speech to Text enables speech transcription for use cases such as speech analytics. Speech is converted to text and analyzed for language patterns that can be tagged and categorized. Speech to text accommodates meetings where the question is verbalized rather than entered as text in a chat. The IBM Watson® Natural Language Understanding (NLU) may extract metadata from text, such as entities, keywords, categories, sentiment, emotion, relations, and syntax. The IBM Watson™ Natural Language Classifier can be used to build custom text classification models to be used to perform Natural Language Processing (NLP) to tokenize and parse language into elemental pieces. The IBM Watson™ Assistant may be used to perform intent recognition. IBM Watson® Natural Language Understanding uses deep learning to extract meaning and metadata from unstructured text to discover categories, classifications, entities, keywords, sentiment, emotion, relations, and syntax. (IBM Watson® Natural Language Understanding is a registered trademark of IBM in the United States. IBM Watson™ Natural Language Classifier and IBM Watson™ Assistant are trademarks of IBM in the United States). IBM NLP includes parsing, stop-word removal, part-of-speech tagging, in addition to tokenizing. NLP processes free form natural language text into a standardized structure that can be input to other processing, as needed. It should be noted that in addition to the various IBM Watson APIs, other deep learning-based models and pre-trained transformer models can be used, for example the BERT language model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

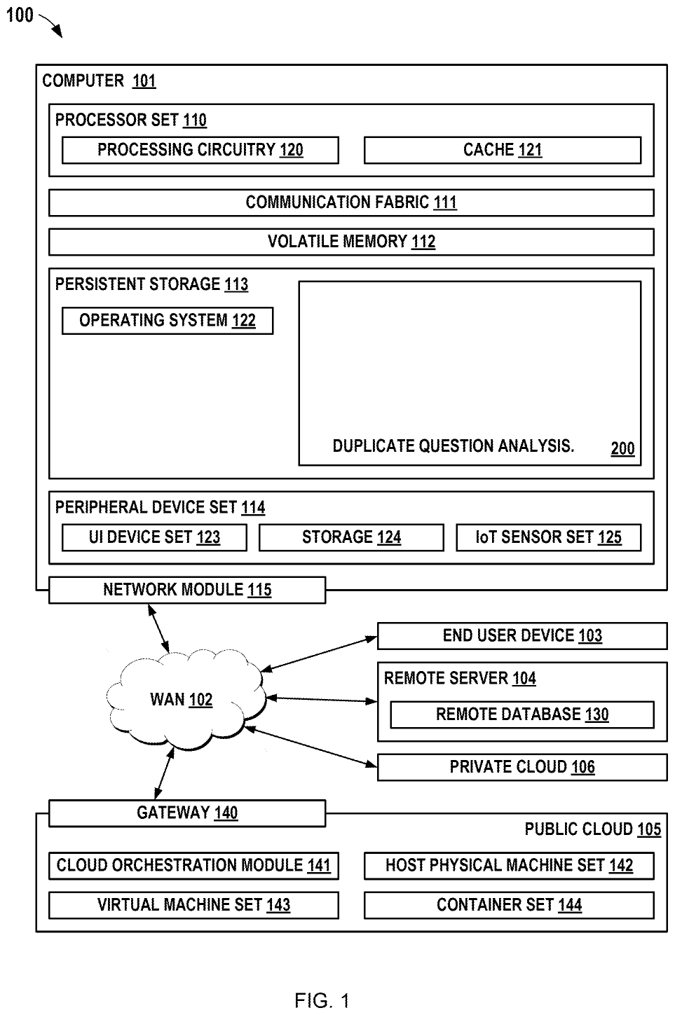

Beginning now with FIG. 1, an illustration is presented of the operating environment of a networked computer, according to an embodiment of the present invention.

Computing environment 100 contains an example of an environment for the execution of at least some of the computer code involved in performing the inventive methods, such as disabling a processor facility without breaking binary compatibility 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

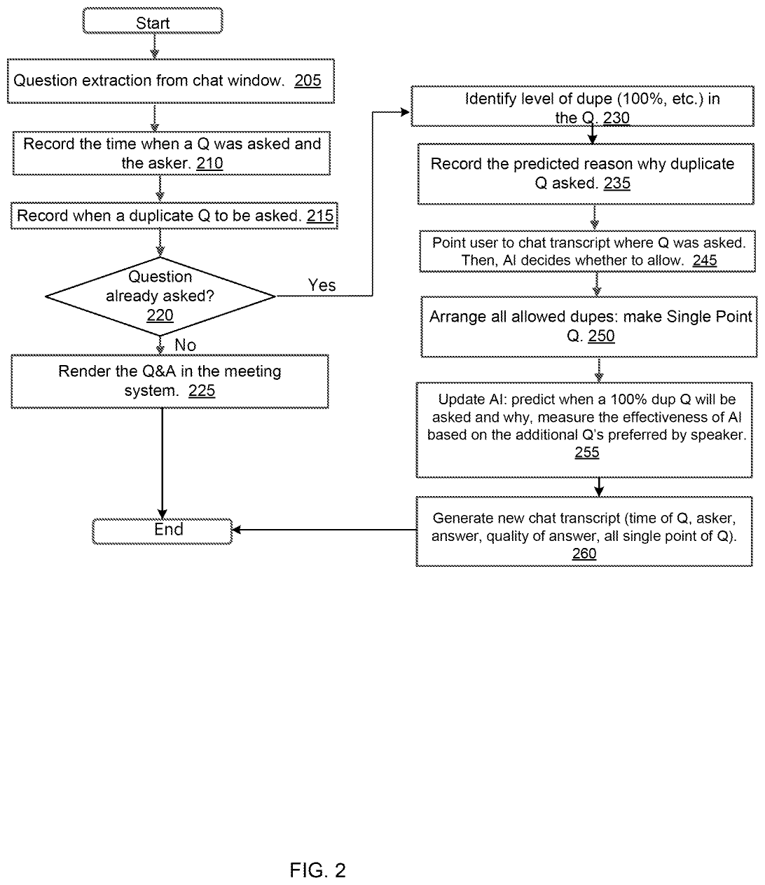

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node (200 of FIG. 2) through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 illustrates a process flow for automatically pointing in a live chat transcript to previously asked question, in accordance with one or more aspects of the present invention.

At 205, the duplicate question analysis (program) 200 extracts each question from the chat, using an available API. Save the extracted questions to a separate storage, such as storage 124, that is accessible to the program 200.

At 210, add a timestamp to each question as it is being extracted, to record the time the question was asked. Also, using an API, extract an identifier associated with the asker, such as an attendee id, screen name, email, etc.

At 215, the program 200 receives a new question that is a possible duplicate question.

At 220, the program 200 uses NLP to determine whether the new question is a duplicate of a previous question. NLP analysis includes comparing the length of the questions, a number of capital letters (indicating multiple embedded questions), punctuation, and similarity of the presence of keywords or the number of overlapping keywords. If it is not, then at 225 the question is allowed to be asked.

If the question is a duplicate, then at 230 the program uses NLP to determine the level of duplication. This can be accomplished by comparing the number of matching elements in the two questions. The result is a percentage of duplication, or a similarity score.

At 235, intent recognition is performed on the duplicate question to determine why the asker presented the question. Intents may be thought of as purposes or goals that are expressed in an asker's question. By recognizing the intent expressed the question, the question can be properly grouped with other similar questions. For example, it is possible that the asker joined the meeting late, that the asker was not paying attention when the information was presented, or that the asker simply did not understand the presenter.

The gap between when the previous question was asked and the current possible duplicate can be a factor in determining whether to allow the duplicate question. For example, if the same/similar question is asked within a configurable period of time, e.g., two minutes, as the previous question, the asker may have an intent, such as being a new participant, not paying attention when the question was previously asked, etc.

Similarly, if the time gap is high compared to a configurable threshold, then perhaps in addition to the above factors, the asker may have forgotten that the question was already asked, or the asker is interested in driving the conversation in a different direction. For example, an attendee previously asked a question about topics T1, T2, and T3, and received a satisfactory response. Subsequently, another asker presents a question about T3 only. In that case, the question can be allowed, as the asker seeks additional details on only T3, and it would not be efficient to refer the asker back to the first question because the focus is on an expansion of T3.

At 245, the program 200 provides the asker with a pointer in the live chat transcript where the duplicate question was previously asked. The program 200 invokes the model to determine whether to allow the duplicate question.

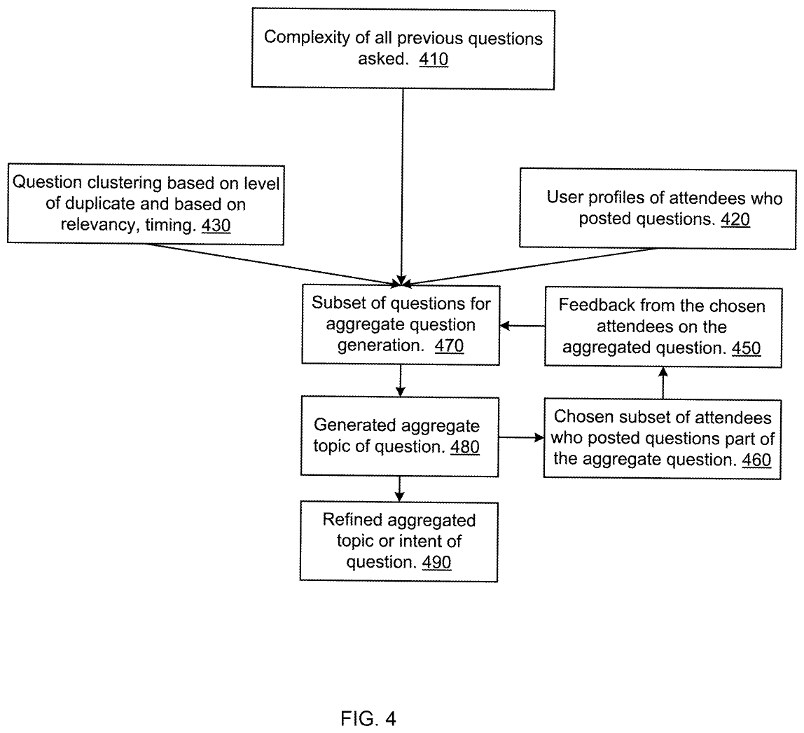

At 250, the program 200 aggregates all allowed duplicate questions into a single point of question, as will be expanded upon with reference to FIG. 4.

At 255, the program 200 updates the model to measure the effectiveness of the training of the model. Measures of effectiveness can include whether the span of questions asked was wider after the use of the model algorithm, whether more questions were asked by different participants, whether the overall count of the questions in the meeting had reduced, whether more material (such as FAQ, URL, learning content, other information such as names of point of contact who can be reached out for a certain topic being discussed, etc.) was shared in the meeting as a result of only good quality (i.e., unique) questions being asked, etc.

At 260, the program 200 generates a new chat transcript that includes the timestamp of the question, the asker, answer (if provided), and all single point questions which may be provided as a link to the aggregated questions.

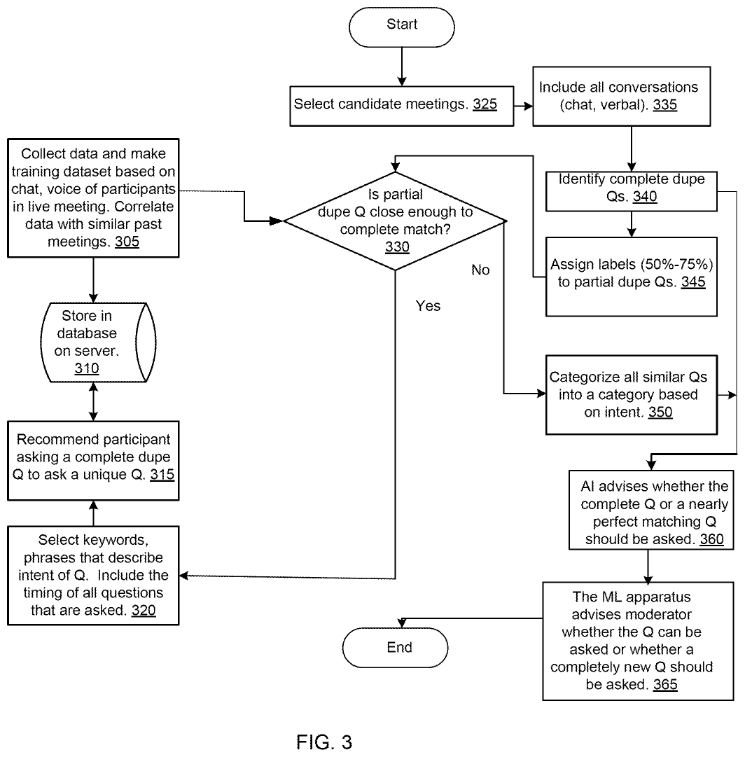

FIG. 3 illustrates a process flow for natural language processing (NLP) in real time of live meetings, in accordance with one or more aspects of the present invention. This includes training and updating the NLP model.

A base NLP model can be trained based on general teleconferencing content and scripts, to improve the model's understanding of the teleconferencing language. Separate models can be trained and customized for specific purposes, such as for a training class or recurring status review meetings, such that the model is tailored to understand particular language features, such as acronyms, cliches, technical terminology. The data for the training dataset includes chat and voice of meeting participants. This data is correlated with data from similar past meetings, which determines how well the data relate to each other (305). The training data is stored, such as in storage 124 for future input to training (310).

At 325, a candidate meeting is selected for processing.

At 335, all chat and verbal conversations from the live meeting are captured for the model. The inputs to the model include question/answer data from the transcript that may be periodically (e.g., every “n” minutes) captured and inputted to the model, and the presentation content.

At 340, the program 200 invokes NLP to determine a degree of duplication of the question to a previously asked question. The question can be 100% duplicate or partially duplicate (<100%). A configurable threshold can define what percentage of match is considered to completely, or nearly completely (e.g. a borderline match), correlate, and the question is labeled (340, 345). For 100% duplicate questions, at 360 the program 200 invokes the trained model to determine whether the question should be allowed.

At 365, the ML (model) advises the moderator whether the question can be asked or whether a completely new question should be asked.

At 330, the program 200 invokes NLP to determine whether the duplicate question is within a configurable threshold of similarity to be considered a complete match to the previously asked question. If not, at 350 the similar, but not matching, duplicate questions are categorized based on intent, and processing continues at 360.

If at 330 a match exists, then at 320 intent recognition analysis is performed, for example, using keywords and phrases parsed from the duplicate question. The timing of the duplicate question relative to the previously asked question is also considered, as described previously.

At 315, based on the results of the intent recognition analysis, the program 200 invokes the model to recommend that the participant ask a new unique question. The duplicate question is stored, such as in storage 124 for future input to training (310).

FIG. 4 illustrates a process flow for generating aggregate duplicate questions, in accordance with one or more aspects of the present invention. It is possible to use Natural Language Understanding and Natural Language Generation to generate summaries from input documents, such as chat transcripts and presentation content, while maintaining the integrity of the information. The questions can be aggregated based on degree of duplication, relevancy to the topic, and timing (430, 480). Multiple aggregate duplicate questions can be generated based on the categories of questions asked by the attendees. The aggregated question is presented to the attendees who asked questions that were its source. Since there is usually time in a meeting before the question/answer session, engaging with attendees can improve the accuracy of the aggregated question by iteratively regenerating and validating with the attendees (450, 460, 490). This also allows attendees to refine their questions or to ask completely different ones. Different subsets of attendees can be selected over the different iterations for diversity. Questions with low complexity can be aggregated with other low complexity questions, or may be aggregated with high complexity questions, but highly complex questions are not aggregated together. The topic of the question, e.g., is it a technology question, length of the questions, whether there are multiple parts/segments to the question, can be used to evaluate complexity (410). The lower the complexity of the questions in the aggregated questions, the more duplicate questions can be aggregated (430, 470). Additionally, questions from the same geography, field of knowledge, or questions from users with similar profiles (as extracted from the teleconferencing application) can be aggregated (420).

What is claimed is:

1. A method, comprising:
training, in real-time a model of questions to identify likely duplicate questions;
identifying a level of duplication between a question and a previously asked question in a meeting transcript;
pointing an asker to where in the meeting transcript the question was the previously asked question;
arranging all duplicate questions in a single point question, wherein each single point question is directed to one similar topic; and
generating a new meeting transcript including each individual question and each single point question.

2. The method of claim 1, wherein the training further comprises:
inputting to the model general teleconferencing content, past meeting transcripts, live chat transcripts, live pre-loaded meeting content, and scripts including specialized language that is customized based on a topic of a meeting.

3. The method of claim 1, further comprising:
performing intent recognition on a duplicate question to analyze the asker's intent;
storing the duplicate question in permanent storage for inputting to the model for training; and
based on the analysis, prompting the asker for a new question, or aggregating the duplicate question with other similar duplicate questions, wherein the aggregated duplicate questions are presented for asking.

4. The method of claim 1, wherein a low configurable time gap between a currently asked duplicate question and a previously asked duplicate question invokes intent analysis to determine whether the duplicate question is allowed.

5. The method of claim 1, further comprising:
aggregating duplicate questions into the single point question based on a degree of duplication, relevancy to a topic, and a gap in timing between the duplicate questions;
preserving the asker identifier of each individual question in the single point question;
presenting the single point question to each asker of each individual question; and
iteratively validating and refining with each asker the single point question for accuracy.

6. The method of claim 1, wherein the new meeting transcript is generated in real-time during the meeting, and includes a timestamp when the question was asked, an asker identifier, each individual question, and each single point question.

7. The method of claim 1, wherein the real-time training includes:
transcribing speech-to-text of audio input for speech analytics, wherein the transcribed speech-to-text is combined with the meeting transcript text;
analyzing the combined speech-to-text and meeting transcript text by NLP to output entities, keywords, categories, sentiment, emotion, relations, and syntax; and
inputting the NLP output to intent recognition analysis to determine an intent and purpose of the asker for the question.

8. A computer program product, the computer program product comprising a non-transitory tangible storage device having program code embodied therewith, the program code executable by a processor of a computer to perform a method, the method comprising:
training, in real-time a model of questions to identify likely duplicate questions;
identifying a level of duplication between a question and a previously asked question in a meeting transcript;
pointing an asker to where in the meeting transcript the question was the previously asked question;
arranging all duplicate questions in a single point question, wherein each single point question is directed to one similar topic; and
generating a new meeting transcript including each individual question and each single point question.

9. The computer program product of claim 8, wherein the training further comprises:
inputting to the model general teleconferencing content, past meeting transcripts, live chat transcripts, live pre-loaded meeting content, and scripts including specialized language that is customized based on a topic of a meeting.

10. The computer program product of claim 8, further comprising:
performing intent recognition on a duplicate question to analyze the asker's intent;
storing the duplicate question in permanent storage for inputting to the model for training; and
based on the analysis, prompting the asker for a new question, or aggregating the duplicate question with other similar duplicate questions, wherein the aggregated duplicate questions are presented for asking.

11. The computer program product of claim 8, wherein a low configurable time gap between a currently asked duplicate question and a previously asked duplicate question invokes intent analysis to determine whether the duplicate question is allowed.

12. The computer program product of claim 8, further comprising:
aggregating duplicate questions into the single point question based on a degree of duplication, relevancy to a topic, and a gap in timing between the duplicate questions;
preserving the asker identifier of each individual question in the single point question;
presenting the single point question to each asker of each individual question; and
iteratively validating and refining with each asker the single point question for accuracy.

13. The computer program product of claim 8, wherein the new meeting transcript is generated in real-time during the meeting, and includes a timestamp when the question was asked, an asker identifier, each individual question, and each single point question.

14. The computer program product of claim 8, wherein the real-time training includes:
transcribing speech-to-text of audio input for speech analytics, wherein the transcribed speech-to-text is combined with the meeting transcript text;
analyzing the combined speech-to-text and meeting transcript text by NLP to output entities, keywords, categories, sentiment, emotion, relations, and syntax; and
inputting the NLP output to intent recognition analysis to determine an intent and purpose of the asker for the question.

15. A computer system, comprising:
one or more processors;
a memory coupled to at least one of the processors;
a set of computer program instructions stored in the memory and executed by at least one of the processors in order to perform actions of:
training, in real-time a model of questions to identify likely duplicate questions;
identifying a level of duplication between a question and a previously asked question in a meeting transcript;
pointing an asker to where in the meeting transcript the question was the previously asked question;
arranging all duplicate questions in a single point question, wherein each single point question is directed to one similar topic; and
generating a new meeting transcript including each individual question and each single point question.

16. The computer system of claim 15, wherein the training further comprises:
inputting to the model general teleconferencing content, past meeting transcripts, live chat transcripts, live pre-loaded meeting content, and scripts including specialized language that is customized based on a topic of a meeting.

17. The computer system of claim 15, further comprising:
performing intent recognition on a duplicate question to analyze the asker's intent;
storing the duplicate question in permanent storage for inputting to the model for training; and
based on the analysis, prompting the asker for a new question, or aggregating the duplicate question with other similar duplicate questions, wherein the aggregated duplicate questions are presented for asking.

18. The computer system of claim 15, wherein a low configurable time gap between a currently asked duplicate question and a previously asked duplicate question invokes intent analysis to determine whether the duplicate question is allowed.

19. The computer system of claim 15, further comprising:
aggregating duplicate questions into the single point question based on a degree of duplication, relevancy to a topic, and a gap in timing between the duplicate questions;
preserving the asker identifier of each individual question in the single point question;
presenting the single point question to each asker of each individual question; and
iteratively validating and refining with each asker the single point question for accuracy.

20. The computer system of claim 15, wherein the real-time training includes:
transcribing speech-to-text of audio input for speech analytics, wherein the transcribed speech-to-text is combined with the meeting transcript text;
analyzing the combined speech-to-text and meeting transcript text by NLP to output entities, keywords, categories, sentiment, emotion, relations, and syntax; and
inputting the NLP output to intent recognition analysis to determine an intent and purpose of the asker for the question.
